(19) United States
(12) Patent Application Publication
(10) Pub. No.: US 2009/0164788 A1
(43) Pub. Date: Jun. 25, 2009

(54) EFFICIENT GENERATION METHOD OF AUTHORIZATION KEY FOR MOBILE COMMUNICATION

(76) Inventors: Seok-Heon Cho, Daejeon (KR); Sung-Cheol Chang, Daejeon (KR); Chul-Sik Yoon, Seoul (KR)

Correspondence Address: STAAS & HALSEY LLP, SUITE 700, 1201 NEW YORK AVENUE, N.W., WASHINGTON, DC, 20005, US

(21) Appl. No.: 12/297,170

(22) PCT Filed: Apr. 19, 2007
(86) PCT No.: PCT/KR2007/001921

§ 371 Date: Oct. 14, 2008

(30) Foreign Application Priority Data
Apr. 19, 2006 (KR) 10-2006-0035471

(51) Int. Cl. H04L 9/32; H04L 9/06

(52) U.S. Cl. 713/175; 380/44

(57) ABSTRACT

The present invention relates to a method of generating an authorization key for a wireless communication system. In the wireless communication system, when an authorization key is generated after authentication between a subscriber station and base station is successfully performed, the authorization key is generated using a value indicating the number of generation times of the authorization key. Subsequently, the subscriber station and the base station confirm through a predetermined procedure whether or not they share the same authorization key and the same number of generation times of the authorization key. According to such a method of generating an authorization key, an authentication function for messages to be transmitted and received between the subscriber station and the base station can be efficiently supported. Further, replay attacks by malignant users can be powerfully protected against.

### TECHNICAL FIELD

The present invention relates to authentication in a wireless communication system, and in particular, to a method of generating an authorization key for an authenticated subscriber station in a wireless communication system.

### BACKGROUND ART

In a wireless communication system that includes a wireless portable Internet service, authorization and authentication procedures for a subscriber station are performed in order to safely provide services. Such functions are attracting attention as the basic requirements for the purpose of safety of wireless communication services and stability of networks. In recent years, a security key management protocol for providing more powerful security, called Privacy Key Management Version 2 (PKMv2), has been suggested. In the PKMv2, with a combination of an Rivest Shamir Adleman (RSA) based authentication mode for mutual authentication of a subscriber station and a base station and an Extensible Authentication Protocol (EAP) based authentication mode using a upper authentication protocol, device authentication for a subscriber station or a base station and user authentication can be performed.

In these authentication modes, when device authentication for a subscriber station or a base station or user authentication are successfully performed, an authorization key is generated. However, a known method of generating an authorization key may not efficiently support a control message authentication function and a reply attack protection function in a wireless communication system.

### DISCLOSURE

### Technical Problem

The present invention has been made in an effort to provide a method of generating an authorization key to support an efficient authentication function for control messages to be transmitted and received between a subscriber station and a base station in a wireless communication system.

The present invention has also been made in an effort to provide a method of generating an authorization key that can cope with malignant replay attacks.

### Technical Solution

An exemplary embodiment of the present invention provides a method of generating an authorization key corresponding to an authenticated subscriber station in a wireless communication system. The method includes: acquiring at least one root key for generating the authorization key through an authentication procedure corresponding to an authentication mode negotiated by a subscriber station and a base station; determining an authorization key generation number; and generating the authorization key on the basis of the root key and the authorization key generation number.

The generation of the authorization key includes: generating an input key through a predetermined operation based on the root key; setting the subscriber station identifier, the base station identifier, the authorization key generation number, and a predetermined string of characters as input data; and generating the authorization key through a key generation algorithm based on the input key and the input data.

Another exemplary embodiment of the present invention provides a method of generating an authorization key corresponding to an authenticated subscriber station in a wireless communication system. The method includes: acquiring, at a base station, an authorization key based on an authorization key generation number; transmitting, at the base station, an SA-Traffic Encryption Key (SA-TEK) challenge message including the authorization key generation number and a message authentication code for performing message authentication function to the subscriber station; receiving, at the base station, an SA-TEK request message from the subscriber station that has received the SA-TEK challenge message, the SA-TEK request message including an authorization key generation number and a message authentication code that have been generated by the subscriber station; and transmitting, at the base station, an SA-TEK response message to the subscriber station so as to confirm that the base station and the subscriber station share the same authorization key and the same authorization key generation number.

Still another exemplary embodiment of the present invention provides a method of generating an authorization key corresponding to an authenticated subscriber station in a wireless communication system. The method includes: receiving, at a subscriber station, an SA-TEK challenge message including an authorization key generation number and a message authentication code for performing message authentication function from a base station; transmitting, at the subscriber station, an SA-TEK request message including an authorization key generation number and a message authentication code to the base station; and receiving, at the subscriber station, an SA-TEK response message from the base station so as to confirm that the base station and the subscriber station share the same authorization key and the same authorization key generation number.

Yet still another exemplary embodiment of the present invention provides a method of generating an authorization key corresponding to an authenticated subscriber station in a wireless communication system. The method includes: generating, at a subscriber station, the authorization key on the basis of an authorization key generation number; transmitting, at the subscriber station, a ranging (RNG) request message including the authorization key generation number and a message authentication code for performing message authentication function to a base station; receiving, at the subscriber station, a RNG response message from the base station that has received the RNG request message, the RNG response message including the authorization key generation number and a message authentication code generated by the base station; and confirming, at the subscriber station, that the subscriber station shares the same authorization key and the same authorization key generation number as the base station when the subscriber station receives the valid RNG response message.

Yet still another exemplary embodiment of the present invention provides a method of generating an authorization key corresponding to an authenticated subscriber station in a wireless communication system. The method includes: receiving, at a base station, a ranging (RNG) request message from the subscriber station, the RNG request message including an authorization key generation number and a message authentication code for performing message authentication function; generating, at the base station, a RNG response message including an authorization key generation number and a message authentication code generated by the base station; and transmitting, at the base station, the RNG response message to the subscriber station so as to confirm that the subscriber station and the base station share the same authorization key and the same authorization key generation number.

The method may further include, if the base station or the subscriber station receives a predetermined message: determining whether or not a message authentication code in the received message is identical to the message authentication code generated in the base station or the subscriber station; determining that the received message is an authorized message when the message authentication codes are same; determining whether or not the authorization key generation number in the received message is identical to the authorization key generation number stored in the base station or the subscriber station; and determining that the base station and the subscriber station share the same authorization key generation number when the authorization key generation numbers are same.

The message authentication code included in the messages may be a code that is generated with a message authorization key derived from an authorization key generated by the base station or the subscriber station.

### DESCRIPTION OF DRAWINGS

FIG. 1 is a diagram showing a network structure of a wireless communication system according to an exemplary embodiment of the present invention;

FIG. 2 is a table showing authentication associated information that is used in an exemplary embodiment of the present invention;

FIG. 3 is a flowchart showing a process of generating an authorization key during a handover;

FIG. 4 is a flowchart showing a method of generating an authorization key according to an exemplary embodiment of the present invention;

FIG. 5 is an exemplary view showing a case where the method of generating an authorization key shown in FIG. 4 is applied to a predetermined authentication procedure;

FIG. 6 is a flowchart showing a method of generating an authorization key according to a first exemplary embodiment of the present invention;

FIG. 7 is a flowchart showing a method of generating an authorization key according to a second exemplary embodiment of the present invention;

FIG. 8 is a flowchart showing a method of generating an authorization key according to a third exemplary embodiment of the present invention; and

FIG. 9 is a flowchart showing a method of generating an authorization key according to a fourth exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

It will be understood that the terms “comprises”, “comprising”, “includes”, and “including”, when used herein, specify the presence of constituent elements, but do not preclude the presence or addition of other constituent elements.

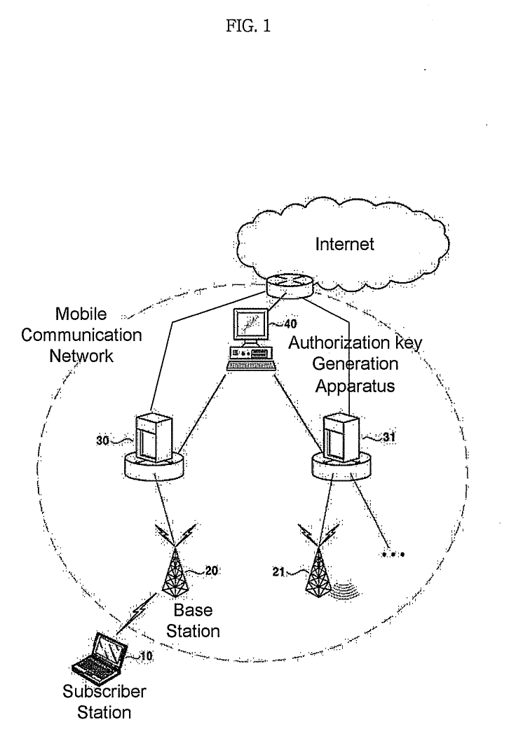

FIG. 1 is a diagram schematically showing a network structure of a wireless communication system according to an exemplary embodiment of the present invention.

The wireless communication system primarily includes a subscriber station 10 (or terminal), base stations 20 and 21, routers 30 and 31 that are connected to the base stations 20 and 21, and an authorization key generation apparatus (authenticator, 40) that is connected to router 30 and 31 so as to manage an authorization key of the subscriber station 10. The authorization key generation apparatus 40 generates, maintains, and manages authentication associated keys according to an exemplary embodiment of the present invention in connection with an authentication server such as Authentication Authorization and Accounting (AAA) Server (not shown). The authorization key generation apparatus 40 can be implemented in various ways. For example, the authorization key generation apparatus 40 may be incorporated into the routers 30 and 31 or may be implemented separately from the routers 30 and 31.

The subscriber station 10 and the base stations 20 and 21 negotiate an authentication mode for authentication on the subscriber station 10 when communication starts, and perform an authentication procedure on the basis of the authentication mode selected according to the negotiation result. An authorization policy to be performed between the subscriber station 10 and the base stations 20 and 21 according to an exemplary embodiment of the present invention is based on the authentication policies according to PKMv2 but is not limited thereto. The authentication policies defined in PKMv2 include various authentication modes according to combinations of a RSA based authentication mode, an EAP based authentication mode, and an authenticated EAP based authentication mode.

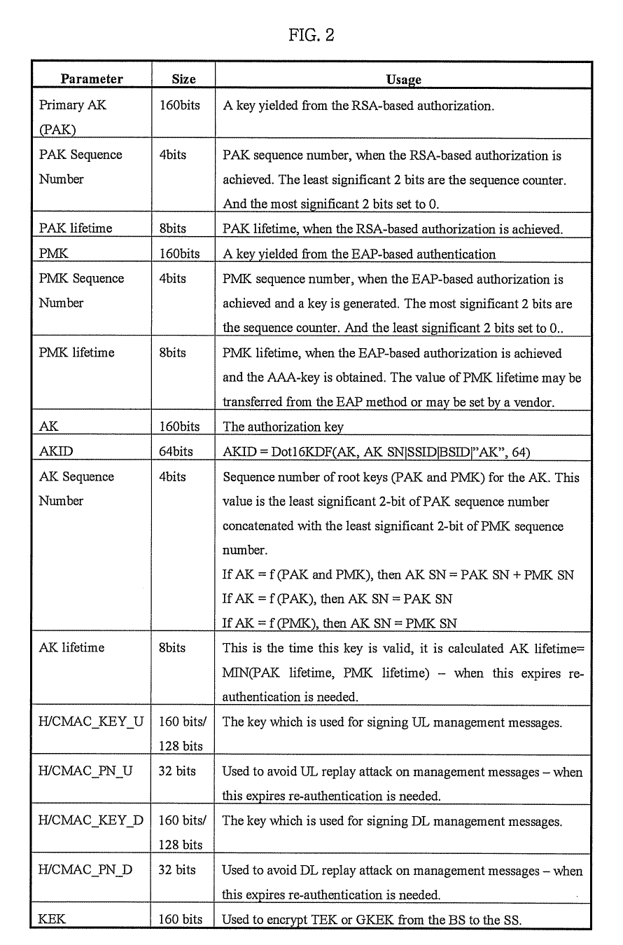

An exemplary embodiment of the present invention supports the RSA-based authentication mode and the EAP-based authentication mode in order to perform device authentication on the subscriber station and the base station or user authentication. FIG. 2 is a table showing authentication associated information to be used in an exemplary embodiment of the present invention. Particularly, FIG. 2 shows a table in which authentication associated information defined in a wireless portable Internet system based on the IEEE 802.16 Wireless MAN system is described.

If the RSA based authentication procedure is successfully performed, the subscriber station 10 and the authorization key generation apparatus 40 share a Primary Authorization Key (PAK) as a root key for generating an authorization key (AK), a PAK sequence number, and PAK lifetime. The PAK is a root key that is safely shared by the subscriber station and the authorization key generation apparatus 40. The PAK sequence number is a number for identifying the PAK. The PAK lifetime denotes lifetime during which the corresponding PAK is used to generate the authorization key.

If the EAP based authentication procedure is successfully performed, the subscriber station 10 and the authorization key generation apparatus 40 share a Pairwise Master Key (PMK) as a root key for generating an authorization key, a PMK sequence number, and PMK lifetime. The PMK is a root key that is safely shared by the subscriber station and the authorization key generation apparatus 40. The PMK sequence number is a number for identifying the PMK. The PMK lifetime denotes lifetime during which the corresponding PMK is used to generate the authorization key.

The subscriber station 10 and the authorization key generation apparatus 40 generate the authorization key with the PAK or PMK shared through the RSA based authentication procedure or the EAP based authentication procedure. Particularly, the base station 20 receives the authorization key generated on the basis of the PAK or the PMK from the authorization key generation apparatus 40. The authorization key supplied to the base station 20 is an authorization key that is shared by the subscriber station 10.

The subscriber station 10 and the authorization key generation apparatus 40 also generate an authorization key sequence number (AK Sequence Number) on the basis of the PAK sequence number or the PMK sequence number. In addition, the minimum value of the PAK lifetime or the PMK lifetime is defined as authorization key lifetime (AK lifetime) and then used. Meanwhile, the authorization key generation apparatus 40 transmits the authorization key, the authorization key sequence number, and the authorization key lifetime to the base station 20 so as to be used for authentication. Further, the subscriber station 10 and the base station 20 generate an authorization key identifier (AKID) on the basis of the authorization key and the authorization key sequence number.

A Message Authentication Code (MAC) mode for a message authentication between the subscriber station 10 and the base station 20 is determined through a subscriber station basic capability negotiation procedure. At this time, according to the determined message authentication mode, Cipher-based Message Authentication Code (CMAC) or Hashed Message Authentication Code (HMAC) is determined as the message authentication code mode. The subscriber station 10 and the base station 20 use a message authentication code mode including at least one of the CMAC and the HMAC to support a message authentication function on a control message.

In order to generate the message authentication code, an uplink message authorization key (HMAC_KEY_U or CMAC_KEY_U) and a downlink message authorization key (HMAC_KEY_D or CMAC_KEY_D) are used. As described above, the uplink and downlink message authorization keys are derived from the authorization key obtained through the authentication procedure.

Particularly, when the CMAC is used to perform the control message authentication function, a counter is used in order to support a replay attack protection function as well as the message authentication function on the control messages. The counter is referred to as “CMAC packet number counter (CMAC_PN_*)”.

The CMAC packet number counter (CMAC_PN_*) has an uplink CMAC packet number counter (CMAC_PN_U) for an uplink from the subscriber station 10 to the base station 20, and a downlink CMAC packet number counter (CMAC_PN_D) for a downlink from the base station 20 to the subscriber station 10. Each time a new authorization key is generated, the value of the CMAC packet number counter (CMAC_PN_*) is reset to an initial value (for example, “0”). Further, each time the subscriber station 10 or the base station 20 creates a new control message and transmits the created control message to a destination node, the value of the CMAC packet number counter (CMAC_PN_*) is increased by a predetermined value (for example, +1).

Meanwhile, the subscriber station 10 and the base station 20 add the CMAC packet number counter (CMAC_PN_*) into a message to be communicated and then transmit the message in order to prevent a replay attack to the corresponding message. The subscriber station 10 and the base station 20 independently manage the CMAC packet number counter (CMAC_PN_*). A receiver that receives the message including the CMAC packet number counter (CMAC_PN_*) determines, according to the relationship between the CMAC packet number counter (CMAC_PN_*) included to the message and the CMAC packet number counter (CMAC_PN_*) previously stored, whether or not the message has undergone the replay attack. For example, the subscriber station 10 or the base station 20 stores a CMAC packet number counter corresponding to a recently received control message. If a CMAC packet number counter corresponding to a newly received control message is smaller than or equal to the previously stored CMAC packet number counter, the subscriber station 10 or the base station 20 determines that the newly received control message has undergone the replay attack, and discards the corresponding message. In such a manner, in addition to the message authentication function on the control message, a replay attack protection function is supported.

Next, a case where the messages are transmitted and received using the above-described various keys will be described.

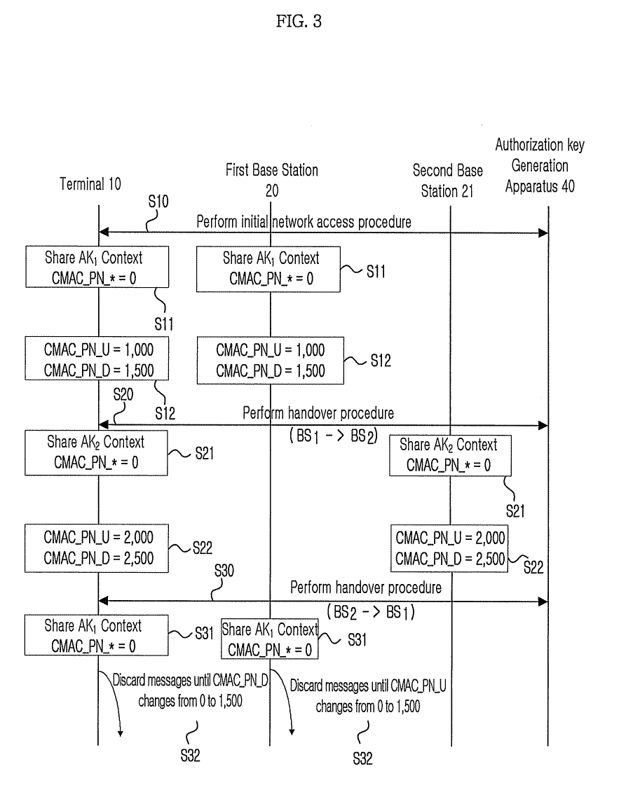

FIG. 3 is a flowchart showing a procedure through which control messages are transmitted and received between a subscriber station and a base station during a handover in a wireless communication system. Particularly, FIG. 3 is a flowchart showing a case where the control messages using the keys are transmitted and received while the subscriber station 10 performs a handover from the first base station 20 to the second base station 21 in an existing wireless communication system.

According to the authorization policy that is supported in the wireless communication system, the subscriber station 10, the first base station 20, the second base station 21, the authorization key generation apparatus 40, and the authentication server performs device authentication on the subscriber station or the base station, or user authentication and completes an initial access procedure (Step S10).

The subscriber station 10 and the authorization key generation apparatus 40 share the PAK or the PMK as a root key for generating the authorization key according to the authorization policy, and derives the authorization key AK₁, the authorization key sequence number, and the authorization key lifetime on the basis of the PAK or the PMK. According to an example of the method of generating an authorization key, a result value according to an exclusive OR operation of the PAK and the PMK is used as an input key, and a combination of the subscriber station Medium Access Control (MAC) address, the base station identifier, and a predetermined string of characters is used as input data. A key generation algorithm is performed using the input data and the input key so as to acquire predetermined data. The acquired data can be used as the authorization key.

The authorization key generation apparatus 40 transmits information including the authorization key AK₁, and the authorization key sequence number and authorization key lifetime corresponding to the authorization key AK₁ to the first base station 20 operating as a current serving base station. Subsequently, the subscriber station 10 and the first base station 20 generate first authorization key context (AK₁ Context) on the basis of the authorization key, the authorization key sequence number, and the authorization key lifetime, and share the generated authorization key context (AK₁ Context). The authorization key context may include uplink and downlink CMAC packet number counters.

The initial values of the uplink and downlink CMAC packet number counters in the first authorization key context are respectively set to “0” (Step S11). The subscriber station and the base station perform message authentication function for the control messages to be transmitted and received by using the CMAC as the message authentication code mode. Further, the subscriber station and the base station add the value of the uplink or downlink CMAC packet number counter into the control messages and transmit the control messages with the value of the uplink or downlink CMAC packet number counter, thereby supporting the replay attack protection function.

Next, it is assumed that the maximum values of the uplink and downlink CMAC packet number counters corresponding to control messages to be recently transmitted and received between the subscriber station 10 and the first base station 20 are 1000 and 1500, respectively (Step S12).

Meanwhile, when a wireless channel environment regarding the first base station 20 that currently provides service to the subscribe station 10 is deteriorated, the subscriber station performs a handover procedure through the base stations 20 and 21 and the authorization key generation apparatus 40 so that the subscriber station 10 continuously receives service from the second base station 21 (Step S20). The handover procedure is a generally known technology, and thus a detailed description of the handover procedure itself thereof will be omitted. If the handover procedure is successfully completed, the subscriber station 10 and the first base station 20 as the previous serving base station delete the first authorization key context (AK₁ Context).

Since the second base station 21 as the target base station to which the subscriber station 10 performs the handover and the first base station 20 as the previous serving base station exist in a mobile area managed by the same authorization key generation apparatus 40, the subscriber station 10 and the authorization key generation apparatus 40 do not need to update the PAK or the PMK. However, since the base station identifier is used as the input data when the authorization key is generated, the authorization key is required to be updated even if the result value of the exclusive OR operation of the same PAKs or the same PMKs is used as the input key. Therefore, when the handover is completed, the subscriber station 10 and the authorization key generation apparatus 40 generate the new authorization key with a plurality of information including the base station identifier of the second base station 21, and also newly generate the authorization key sequence number and the authorization key lifetime. Particularly, the authorization key generation apparatus 40 transmits the newly generated authorization key, authorization key sequence number, and authorization key lifetime to the second base station 21 operating as a current serving base station.

The subscriber station 10 and the second base station 21 generate second authorization key context (AK₂ Context) on the basis of the authorization key, the authorization key sequence number, and the authorization key lifetime, and share the generated second authorization key context (AK₂ Context). In this case, similarly, the initial values of the uplink and downlink CMAC packet number counters in the second authorization key context are respectively set to “0” (Step S21). Next, it is assumed that the maximum values of the uplink and downlink CMAC packet number counters corresponding to the control messages to be transmitted and received between the subscriber station 10 and the second base station 21 are 2000 and 2500, respectively (Step S22).

As such, while the subscriber station 10 receives services from the second base station 21, if the wireless channel environment between the subscriber station 10 and the second base station 21 deteriorates, the subscriber station 10 may perform the handover procedure to the previous first base station 20. In this case, the subscriber station 10 performs the handover procedure through the base stations 20 and 21 and the authorization key generation apparatus 40 (Step S30).

Since the first base station 20 exists in an area managed by the same authorization key generation apparatus as the second base station 21 which is the previous serving base station, the subscriber station 10 and the authorization key generation apparatus 40 do not need to update the PAK or the PMK, and regenerate the authorization key on the basis of a plurality of information including the identifier of the first base station. The authorization key, the authorization key sequence number, and the authorization key lifetime generated by the authorization key generation apparatus 40 are transferred to the first base station 20.

The newly generated authorization key is identical to the authorization key that was already shared by the subscriber station 10 and the first base station 20 through the initial access procedure (Step S10). That is, the authorization key context generated by the subscriber station 10 and the first base station 20 is also identical to the first authorization key context (AK₁ Context) that was already shared by the subscriber station 10 and the first base station 20 through the initial access procedure. In this case, similarly, as the authorization key is generated, the initial values of the uplink and downlink CMAC packet number counters in the first authorization key context are respectively set to “0” (Step S31).

However, from that time, the subscriber station 10 and the base station 20 may come under a replay attack from a malignant user. For example, it is assumed that the malignant user stores all of the last control messages transmitted and received between the subscriber station 10 and the first base station 20 after the initial access procedure (Step S10) of the subscriber station is completed. Of course, these control messages include the CMAC as the message authentication code mode and the uplink or downlink CMAC packet number counter.

In this state, when the subscriber station that have performed the handover from the first base station 20 to the second base station 21 performs the handover back to the first base station 20 again, even if the malignant user transmits approximately 1500 stored control messages to the subscriber station 10 until the downlink CMAC packet number counter changes from 0 to 1500, the subscriber station 10 regards these messages as the messages transmitted from the authorized base station and responds to these messages. Further, even if the malignant user transmits approximately 1000 stored control messages to the base station 21 until the uplink CMAC packet number counter changes from 0 to 1000, the base station 20 regards these messages as the messages transmitted from the authorized subscriber station and responds to these messages. These messages caused by the replay attack are required to be discarded (Step S32).

As such, even if the CMAC packet number counter is added to the control messages transmitted and received between the subscriber station and the base station and the control messages with the CMAC packet number counter are transmitted, the control messages may come under the replay attack from the malignant user. If the control messages come under the replay attack, erroneous operations of the subscriber station and the base station may occur. Further, if the attack range becomes wider, system performance may be deteriorated.

Accordingly, in the exemplary embodiment of the present invention, various procedures that completely support the reply attack protection function and the message authentication function on the control messages that is transmitted and received between the subscriber station and the base station can be performed. Further, in the exemplary embodiment of the present invention, the authorization key that is shared by the subscriber station and the base station is powerfully and efficiently generated. That is, since the authorization key context as well as the authorization key is provided with enough safety, in addition to the message authentication function on the control messages to be transmitted and received between the subscriber station and the base station, the protection function against the replay attack from the malignant user is completely supported. Therefore, it causes stable operation and better performance in a wireless system.

Next, a method of generating an authorization key according to an exemplary embodiment of the present invention will be described in detail.

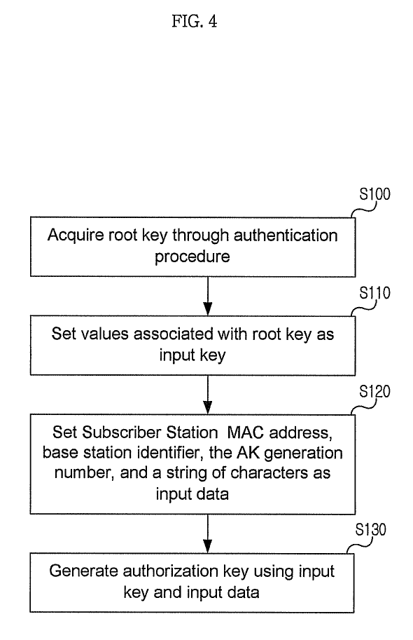

FIG. 4 is a diagram showing a method of generating an authorization key according to an exemplary embodiment of the present invention.

In a wireless communication system, such as a wireless portable Internet system, various authentication procedures are performed according to the authentication policies of the service providers. After performing the authentication procedure, the root keys for generating the authorization key are acquired. Then, the authorization key is generated with the root keys and a plurality of information on the subscriber station or the base station.

As described above, as the root keys, the PAK or/and the PMK obtained through the RSA authentication procedure or the EAP authentication procedure may be used. Further, the subscriber station identifier is used for the information regarding the subscriber station, and the base station identifier is used for the information regarding the base station. Here, the MAC address of the subscriber station is used as the subscriber station identifier, but the present invention is not limited thereto.

In the exemplary embodiment of the present invention, the authorization key is generated using the key generation algorithm. In this case, a value obtained from the root keys is used as the input key, and data including the subscriber station MAC address, the base station identifier, and the authorization key generation number is used as the input data. As the input data, in addition to the subscriber station MAC address, the base station identifier, the authorization key generation number, and data having a predetermined string of characters, for example a string of characters “AK”, is used.

Specifically, as shown in FIG. 4, the subscriber station 10 and the authorization key generation apparatus 40 share the root key for generating the authorization key after a predetermined authentication procedure (Step S100). A result value that is obtained by performing a predetermined operation on the root key is set as the input key (Step S110), and the subscriber station MAC address, the base station identifier, the authorization key generation number, and the string of characters “AK” are set as the input data (Step S120).

The authorization key generation number indicates a value representing the number of authorization keys that have been generated by the subscriber station 10 and the authorization key generation apparatus 40, since the subscriber station performed the initial access procedure. The authorization key is newly generated in a case where an initial authentication procedure between the subscriber station and the base station is performed, a case where a re-authentication procedure is performed, a case where the CMAC packet number counter overflows, a case where the handover procedure is successfully performed, a case where the handover is canceled, a case where the location of the subscriber station is updated, or a case where a drop procedure for the subscriber station is performed.

Next, the key generation algorithm is performed using the input key as well as the input data. Result data that is obtained through the key generation algorithm is used as the authorization key (Step S130). Here, as the key generation algorithm, “Dot16KDF” using the CMAC algorithm may be used, but the present invention is not limited thereto.

A case where the method of generating an authorization key according to an exemplary embodiment of the present invention is applied when the RSA based authentication procedure is achieved and then the EAP based authentication procedure is performed will be described.

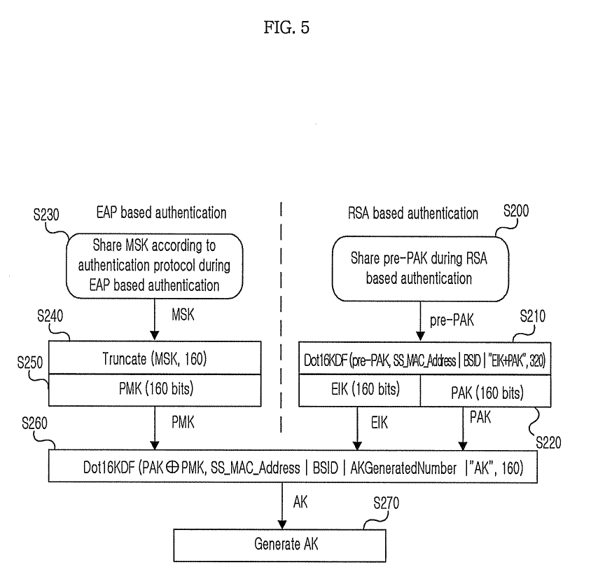

FIG. 5 is a flowchart showing a case where the method of generating an authorization key according to an exemplary embodiment of the present invention is applied to an authentication method that performs the EAP based authentication procedure after the RSA based authentication procedure.

If the RSA based authentication procedure is successfully completed, as shown in FIG. 5, the subscriber station 10 and the authorization key generation apparatus 40 share a pre-PAK (for example, 256 bits) (Step S200).

The pre-PAK may be randomly generated by the authorization key generation apparatus 40. In this case, the authorization key generation apparatus 40 encrypts the pre-PAK with a subscriber station public key and transmits the encrypted pre-PAK to the subscriber station 10. The encrypted pre-PAK can be decoded by only the subscriber station that has the secret key corresponding to the subscriber station public key.

The subscriber station 10 and the authorization key generation apparatus 40 performs the key generation algorithm using the pre-PAK as the input key and the subscriber station MAC address SS_MAC_Address, the base station identifier BSID, and a string of characters “EIK+PAK” as the input data, thereby obtaining result data (Step S210).

A predetermined number of bits, for example 320 bits, are truncated from the result data, and a predetermined number of bits from the truncated data, for example the most significant 160 bits, are used as an EIK (EAP Integrity Key). The remaining bits, for example the least significant 160 bits, are used as the PAK (Step S220).

Meanwhile, if the EAP based authentication procedure is successfully completed after performing the RSA based authentication procedure, the subscriber station 10 and the authorization key generation apparatus 40 share a 512-bit Master Session Key (MSK) according to an upper EAP authentication protocol characteristic (Step S230). When sharing the MSK, the subscriber station 10 and the authorization key generation apparatus 40 truncate a predetermined number of bits of the MSK, for example the most significant 160 bits. The truncated 160-bit data is used as the PMK (Steps S240 to S250).

As described above, a predetermined operation (e.g., an exclusive OR operation) of the PAK and the PMK is performed, and the result value of the predetermined operation is set as the input key. Further, the subscriber station MAC address SS_MAC_Address, the base station identifier BSID, the authorization key generation number AKGeneratedNumber, and a string of characters “AK” are set as the input data. Then, the key generation algorithm is performed using the input key. A predetermined number of bits, for example the most significant 160 bits, are truncated from the result data obtained through the key generation algorithm, and the truncated-bit data is used as the authorization key AK (Steps S260 and S270).

In addition, the method of generating an authorization key according to an exemplary embodiment of the present invention may be applied to a case where only the RSA based authentication procedure is performed and only the PAK is acquired as the root key, or a case where only the EAP based authentication procedure is performed and only the PMK is acquired as the root key. In this case, the key generation algorithm is performed using only the PAK or the PMK as the input key and the subscriber station MAC address, the base station identifier, the authorization key generation number, and a string of characters “AK” as the input data. Further, a predetermined number of bits from the result data are used as the authorization key AK. Alternatively, the method of generating an authorization key according to an exemplary embodiment of the present invention may be applied to a case where the RSA based authentication procedure is achieved and then authenticated EAP based authentication procedure is performed. In this case, the authorization key can be generated through the process as shown in FIG. 5.

According to the above-described method, the authorization key is generated on the basis of the authorization key generation number. Therefore, it is possible to generate a strong authorization key that can support the replay attack protection function while having a systematic structure. Particularly, since the control messages are transmitted and received on the basis of the authorization key and the authorization key generation number, a strong protection function against the replay attack made by the malignant user who is not involved in generating the authorization key can be achieved.

In order to support the replay attack protection function while performing authentication on the control messages, as described above, the generated authorization key should be efficiently used, and particularly, the authorization key generation number indicating the number of generation times of the authorization key should be correctly used.

The authorization key generation number is managed separately by the subscriber station 10 and the authorization key generation apparatus 40. Each time the nodes generate the authorization key, the authorization key generation number increments by a predetermined value (for example, +1). Further, when the authorization key is initially generated, the authorization key generation number has an initial value of, for example, “1”. The authorization key generation apparatus 40 transmits, to the base station 20, the authorization key, the authorization key sequence number, the authorization key lifetime, and the authorization key generation number increased each time the authorization key is generated.

Each time a new authorization key is generated, the subscriber station 10 and the base station 20 need to confirm whether or not they correctly share the authorization key, the authorization key sequence number, the authorization key lifetime, and the authorization key generation number.

In the exemplary embodiment of the present invention, it is confirmed through a 3 way SA-Traffic Encryption Key (SA-TEK) procedure between the subscriber station and the base station whether or not the authorization key generation number as well as the authorization key are correctly shared. Further, it is confirmed through a Ranging-Request/Response (RNG-REQ/RSP) between the subscriber station and the base station whether or not the authorization key generation number as well as the authorization key are correctly shared.

For example, when the authorization key is updated in a case where the initial authentication procedure between the subscriber station and the base station is performed, a case where the re-authentication procedure is performed, or a case where the CMAC packet number counter overflows, it is determined through the 3 way SA-TEK procedure whether or not the new authorization key and the new authorization key generation number are correctly shared. Further, when the authorization key is updated in a case where the handover procedure is successfully performed, a case where the location of subscriber station is updated, or a case where the drop procedure for the subscriber station is performed, it is determined through the RNG-REQ/RSP procedure whether or not the new authorization key and the new authorization key generation number are correctly shared.

Next, a method for confirming information regarding an additionally generated authorization key while generating an authorization key according to an exemplary embodiment of the present invention will be described. In the methods of generating an authorization key according to individual exemplary embodiments described below, the authorization key is primarily generated by the method shown in FIG. 4.

First, an authorization key generation method performed when re-authentication is performed after an initial network access procedure of the subscriber station is performed according to a first exemplary embodiment of the present invention will be described.

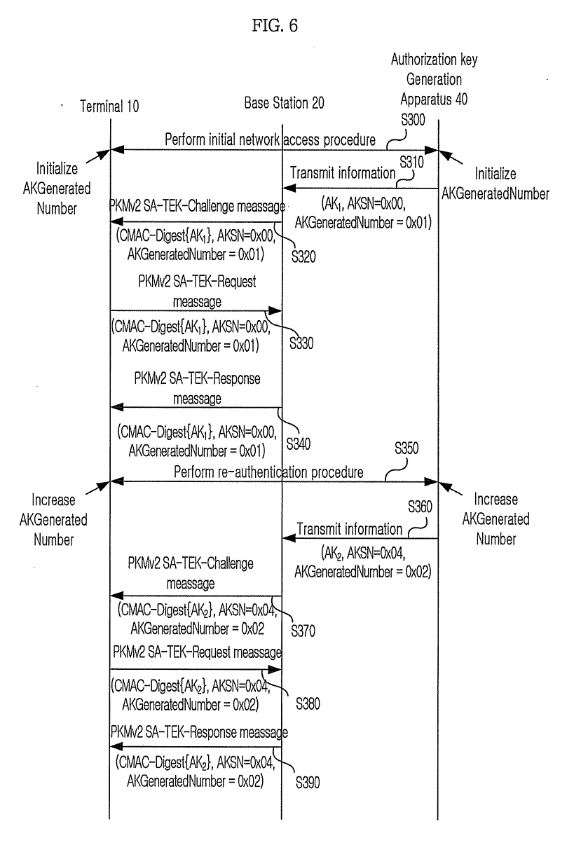

FIG. 6 is a flowchart illustrating a method of generating an authorization key according to the first exemplary embodiment of the present invention.

The subscriber station 10 performs the initial access procedure of the system in connection with the base station 20, the authorization key generation apparatus 40, and the authentication server (not shown) (Step S300).

If the authentication procedure (for example, the RSA based authentication procedure or the EAP based authentication procedure) in the initial access procedure is successfully completed, the subscriber station 10 and the authorization key generation apparatus 40 generate a first authorization key AK₁ according to the method shown in FIG. 5, and also generate an authorization key sequence number and authorization key lifetime corresponding to the first authorization key AK₁. In this case, since the authorization key is initially generated on the corresponding subscriber station, the authorization key generation number is set as an initial value, for example “1”, and the first authorization key (AK₁) is generated with the authorization key generation number (Step S300). The authorization key generation apparatus 40 transmits, to the base station 20, the first authorization key AK₁, the authorization key sequence number (AKSN), the authorization key lifetime, and the authorization key generation number AKGeneratedNumber set to “1” generated in the above-described manner (Step S310).

The base station 20 performs the SA-TEK procedure as described below in order to confirm whether or not the authorization key, the authorization key sequence number, and the authorization key generation number received from the authorization key generation apparatus 40 are identical to those stored in the subscriber station 10.

First, in order to notify the start of the SA-TEK procedure, the base station 20 transmits a PKMv2 SA-TEK-Challenge message, which is called “SA-TEK challenge message”, to the subscriber station 10 (Step S320).

The PKMv2 SA-TEK-Challenge message includes the authorization key sequence number, the authorization key generation number (here, 0x01), and the message authentication code for performing control message authentication. The message authentication code is generated using a message authorization key derived from the first authorization key AK₁.

Here, as the message authentication code mode, the CMAC is used. Therefore, the control message includes CMAC-Digest as the message authentication code. Alternatively, as the message authentication code mode, the HMAC may be used. In this case, the control message includes HMAC-Digest as the message authentication code. When the message authorization key (an uplink message authorization key CMAC_KEY_U or HMAC_KEY_U and a downlink message authorization key CMAC_KEY_D or HMAC_KEY_D) used to generate the message authentication code can be generated using the authorization key (here, AK₁). The message authentication code is generated by applying the message authorization key and the remaining parameters, excluding the CMAC, from the PKMv2 SA-TEK-Challenge message to a message hash function.

Meanwhile, the subscriber station 10 that receives the PKMv2 SA-TEK-Challenge message performs message authentication on the basis of CMAC-Digest as the message authentication code in the message and the authorization key generation number.

For example, a new CMAC-Digest is generated by applying the remaining parameters, excluding CMAC-Digest, from the PKMv2 SA-TEK-Challenge message to the message hash function. Then, when newly generated CMAC-Digest and CMAC-Digest in the PKMv2 SA-TEK-Challenge message are same, it is considered that message authentication succeeds. When they are different from each other, it is considered that message authentication fails.

When message authentication based on CMAC-Digest as the message authentication code succeeds, the subscriber station 10 confirms whether or not the authorization key generation number in the received PKMv2 SA-TEK-Challenge message and the authorization key generation number stored therein are same. If the numbers are same, it is considered that the subscriber station 10 shares the authorization key and the authorization key generation number that are identical to those of the base station 20, and then performs a predetermined processing on the basis of the PKMv2 SA-TEK-Challenge message. However, if the numbers are different from each other, it is considered that message authentication fails, and the received PKMv2 SA-TEK-Challenge message is discarded. Although the identity between the authorization key generation numbers is confirmed after the identity between the message authentication codes is confirmed, the present invention is not limited to this sequence.

As such, in the exemplary embodiment of the present invention, a process of determining whether CMAC-Digest that is the message authentication code and the authorization key generation number included in the received message are the same as the generated CMAC-Digest and the stored authorization key generation number is collectively referred to as an “authorization key identity confirmation process”. Subsequently, as occasion demands, the detailed description of an authorization key identity confirmation process to be performed in the same manner as described above will be omitted.

Next, the subscriber station 10 transmits a PKMv2 SA-TEK-Request message, which is called “SA-TEK request message”, as a response to the “SA-TEK challenge message” to the base station 20 (Step S330). The PKMv2 SA-TEK-Request message includes CMAC-Digest as the message authentication code, which is generated with the message authorization key derived from the first authorization key stored in the subscriber station, and the authorization key generation number set to “1”.

Similar to the authorization key identity confirmation process performed by the subscriber station 10, the base station 20 that receives the PKMv2 SA-TEK-Request message performs message authentication on the basis of the message authentication code and the authorization key generation number, and determines whether or not it shares the authorization key and the authorization key generation number that are identical to those of the subscriber station.

The base station 20 that successfully receives the “SA-TEK request message” transmits a PKMv2 SA-TEK-Response message, which is called “SA-TEK response message”, to the subscriber station 10. In this case, for simple confirmation, the message authentication code for message authentication and the authorization key generation number are added to the PKMv2 SA-TEK-Response message (Step S340).

If the subscriber station 10 receives the valid PKMv2 SA-TEK-Response message, the SA-TEK procedure is completed, and it is considered that the subscriber station 10 and the base station 20 correctly share the new authorization key AK₁ and the updated authorization key generation number 00x1. In this case, the subscriber station 10 performs the authorization key identity confirmation process on the PKMv2 SA-TEK-Response message, and, only when this process is successfully performed, the SA-TEK procedure is completed.

Next, if the lifetime of the PAK or the PMK which has been stored in the subscriber station and the base station through the initial authentication procedure expires, a re-authentication procedure is performed to update the corresponding PAK or PMK (Step S350).

If the re-authentication procedure is successfully completed, the subscriber station and the authorization key generation apparatus 40 increase the authorization key generation number by a predetermined value, for example +1 with respect to the corresponding subscriber station, and set the authorization key generation number to “2”. Then, a second authorization key is generated on the basis of the increased authorization key generation number, and an authorization key sequence number and an authorization key lifetime are also generated. The authorization key generation apparatus 40 transmits, to the base station 20, the second authorization key AK₂, the authorization key sequence number (0x04), the authorization key lifetime, and the authorization key generation number (0x02) set to “2” that are generated according to the re-authentication procedure (Step S360).

Next, the base station 20 and the subscriber station 10 perform the SA-TAK procedure according to Steps S320 to S340, and confirm whether or not the authorization keys, the authorization key sequence numbers, and the authorization key generation number stored therein are same (Steps S370 to S390). If the subscriber station 10 correctly receives the PKMv2 SA-TEK-Response message through the SA-TEK procedure, it is considered that the subscriber station 10 and the base station 20 correctly share the new authorization key AK₂ and the updated authorization key generation number (0x02).

Meanwhile, even if the subscriber station continuously receives services from the same base station and has the same PAK or PMK, a new authorization key can be generated before the lifetime of the PAK or PMK expires. As such, if re-authentication is performed as the new authorization key is generated, as described above according to the exemplary embodiment of the present invention, a procedure of confirming whether or not the subscriber station and the base station share the new authorization key and the new authorization key generation number is performed. Accordingly, the authorization key and authorization key context have a strong system against the replay attack.

Next, an authorization key generation method that is performed when the CMAC packet number counter overflows according to the second exemplary embodiment of the present invention will be described. Here, a detailed description of a process performed in the same manner as the method of generating an authorization key according to the first exemplary embodiment will be omitted.

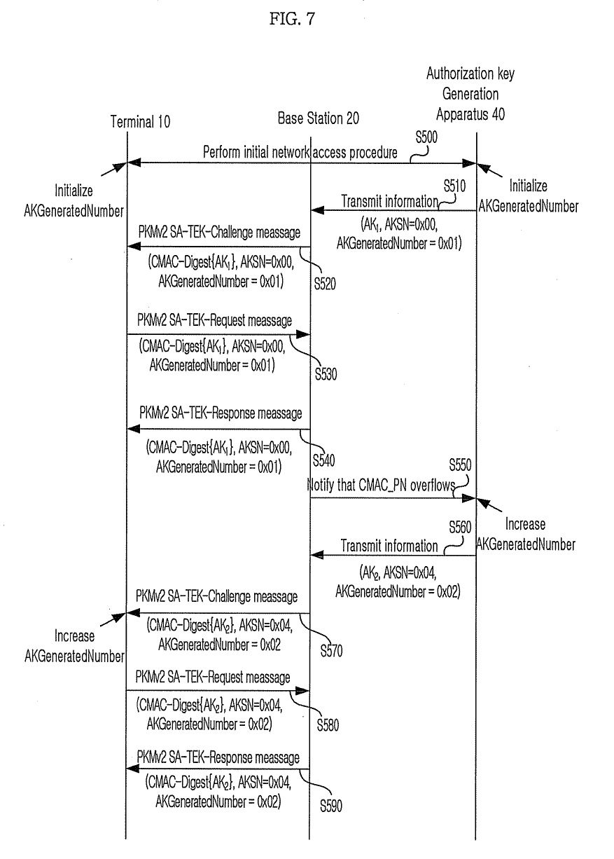

FIG. 7 is a flowchart illustrating a method of generating an authorization key according to the second exemplary embodiment of the present invention.

If the authentication procedure in the initial access procedure is successfully completed, the subscriber station 10 and the authorization key generation apparatus 40 set the authorization key generation number as the initial value, for example “1”, and generate the first authorization key AK₁ on the basis of the authorization key generation number. Next, the authorization key sequence number and the authorization key lifetime are generated (Step S500).

Next, similar to the first exemplary embodiment, the base station 20 performs the SA-TAK procedure in order to confirm whether or not the authorization key, the authorization key sequence number, and the authorization key generation number supplied from the authorization key generation apparatus 40 are identical to those stored in the subscriber station 10 (Steps S510 to S540). If the subscriber station 10 appropriately receives the PKMv2 SA-TEK-Response message through the SA-TAK procedure, it is considered that the subscriber station 10 and the base station 20 appropriately share the authorization key AK₁ and the updated authorization key generation number (0x01).

Next, the subscriber station 10 and the base station 20 transmits/receives the control messages according to a predetermined procedure. Each time the control message is transmitted to the destination node, the subscriber station 10 and the base station 20 increase the value of the corresponding CMAC packet number counter (for example, +1), add the value of the corresponding counter to the control message, and transmit the control message.

Before the value of the CMAC packet number counter exceeds a predetermined value, it is necessary to update the authorization key. A predetermined counter value before the value of the CMAC packet number counter exceeds the predetermined value is referred to as a CMAC packet number counter grace number (CMAC_PN_*Grace Number). For convenience of explanation, the CMAC packet number counter grace number is referred to as “grace number”. The value of the uplink CMAC packet number counter and the value of the downlink CMAC packet number counter have the same grace number. The subscriber station and the base station can negotiate the grace number through a subscriber station basic capability negotiation procedure (SBC-REQ/RSP) in the subscriber station initial access procedure.

The base station 20 confirms whether or not the value of the uplink packet number counter and the value of the downlink packet number counter are identical to the grace number. That is, when the value of the uplink packet number counter in the control message received from the subscriber station 10 reaches the grace number, or when the value of the downlink packet number counter in the control message to be transmitted to the subscriber station 10 reaches the grace number, the base station 20 informs the authorization key generation apparatus 40 that the value of the CMAC packet number counter (CMAC_PN) exceeds the predetermined value (Step S550).

When notified that the value of the CMAC packet number counter exceeds the predetermined value, the authorization key generation apparatus 40 generates the authorization key again. That is, the second authorization key is generated relative to the corresponding subscriber station. Accordingly, the authorization key generation number is increased by “1” and is set to “2”, and then the second authorization key AK₂ is generated. Further, the authorization key sequence number and the authorization key lifetime corresponding to the second authorization key AK₂ are generated.

The base station 20 receives the second authorization key AK₂, the authorization key sequence number, the authorization key lifetime, and the authorization key generation number set to “2” from the authorization key generation apparatus 40 (Step S560). Then, similar to the first exemplary embodiment, the base station 20 performs the SA-TAK procedure in order to confirm whether or not they are identical to those stored in the subscriber station.

Particularly, in the second exemplary embodiment, the base station 20 adds the authorization key sequence number, the authorization key generation number (0x02) set to “2”, and CMAC-Digest to the PKMv2 SA-TEK-Challenge message. Here, the message authentication code is generated using the message authorization key derived from the second authorization key AK₂. Particularly, a field indicating that the authorization key is to be updated because of the CMAC packet number counter overflow is added to the PKMv2 SA-TEK-Challenge message. Then, the PKMv2 SA-TEK-Challenge message is transmitted to the subscriber station 10 (Step S570). For convenience of explanation, this field is referred to as “authorization key update indication field”.

The subscriber station 10 that receives the PKMv2 SA-TEK-Challenge message recognizes, on the basis of the received authorization key update indication field, that the intention of the base station to transmit the message is to update the authorization key because of the CMAC packet number counter overflow. Then, the authorization key generation number is increased by “1” and is set to “2”, and the new authorization key AK₂ is generated on the basis of the authorization key generation number.

Further, message authentication is performed on the basis of CMAC-Digest in the PKMv2 SA-TEK-Challenge message. If message authentication is performed, it is determined that the subscriber station 10 shares the same authorization key with the base station. Next, if the authorization key generation number in the received PKMv2 SA-TEK-Challenge message is identical to the authorization key generation number generated by the subscriber station, the subscriber station determines that it shares the same authorization key generation number with the base station and processes the PKMv2 SA-TEK-Challenge message.

Subsequently, the subscriber station 10 transmits, to the base station, CMAC-Digest, which is generated using the message authorization key derived from the second authorization key AK₂ generated in the above-described manner, and the PKMv2 SA-TEK-Request message including the authorization key generation number set to “2” (Step S580).

Similar to the first exemplary embodiment, the base station 20 also performs authentication on the PKMv2 SA-TEK-Request message, and if it is confirmed that the subscriber station shares the authorization key and the authorization key generation number that is identical to those of the base station 20 thereof, transmits the PKMv2 SA-TEK-Response message to the subscriber station 10 (Step S590). If the subscriber station 10 correctly receives the PKMv2 SA-TEK-Response message, it is considered that the subscriber station 10 and the base station 20 correctly share the new authorization key and the updated authorization key generation number.

According to this exemplary embodiment, when the CMAC packet number counter overflows, it is possible to update the authorization key without performing the unnecessary re-authentication procedure. Further, since the procedure of confirming whether or not the subscriber station and the base station share the new authorization key and the authorization key generation number is performed, the authorization key and the authorization key context have a strong system against the replay attack.

Next, a method of generating an authorization key according to a third exemplary embodiment of the present invention, which is performed during a handover, will be described. Here, a detailed description of a process performed in the same manner as the method of generating an authorization key according to the first exemplary embodiment will be omitted.

In the third exemplary embodiment of the present invention, each time a handover is performed, for example when the subscriber station performs a handover from the first base station to the second base station or a handover from the second base station to the first base station, it is configured such that the subscriber station and the base station share new authorization key context. A detailed process through which the subscriber station performs a handover from a serving base station to a target base station can be designed by a person of ordinary skill in the art. Accordingly, the detailed description thereof will be omitted, and a description will be given laying focus on the generation and confirmation of the authorization key.

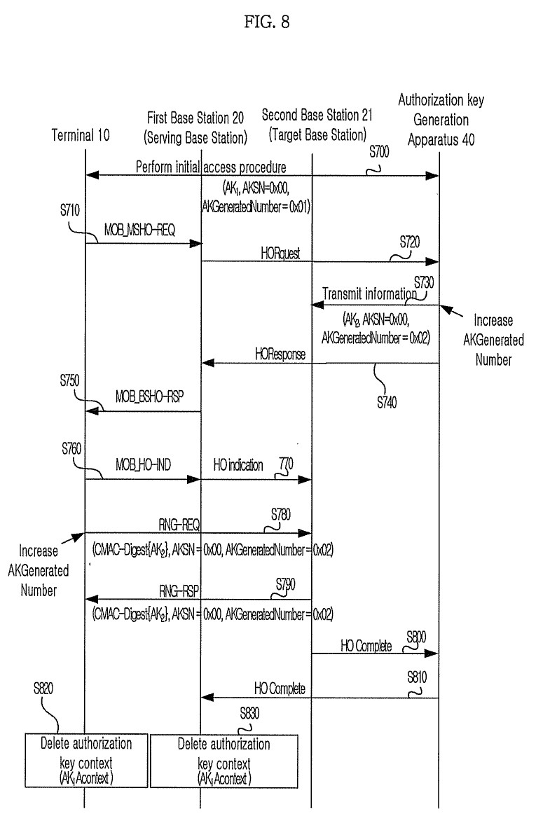

FIG. 8 is a flowchart illustrating a method of generating an authorization key according to the third exemplary embodiment of the present invention.

As shown in FIG. 8, the subscriber station 10 performs an initial access procedure with respect to the first base station 20, and the subscriber station 10 and the first base station 20 share the first authorization key AK₁ and the authorization key generation number (0x01) set to the initial value “1” (Step S700). In this case, the subscriber station 10 and the first base station 20 generate the first authorization key context (AK₁ Context) and share this first authorization key context (AK₁ Context). As the authorization key context, uplink/downlink CMAC packet number counter is included.

Subsequently, when recognizing deterioration of the wireless channel environment relative to the first base station 20, the subscriber station 10 transmits a Mobility_Mobile Station HandOver-Request (MOB_MSHO-REQ) message as a handover request message to the first base station 20 in order to perform a handover to a new base station (Step S710).

The first base station 20 that receives the MOB_MSHO-REQ message transmits an HO Request message as a request message to request a handover to the authorization key generation apparatus 40 (Step S720). The authorization key generation apparatus 40 recognizes the update of the authorization key according to the handover in response to the HO Request message, and increases the authorization key generation number by “1” and sets the authorization key generation number to “2”. Subsequently, the authorization keys (different authorization keys are generated on the basis of unique base station identifier of target base stations) corresponding to the subscriber station that challenges a handover to the target base stations are generated, and each of the generated authorization keys and each of the authorization key generation numbers are transmitted to the corresponding target base station (S730). Here, while the authorization keys to be supplied to the target base stations are different from each other, the authorization key generation numbers are same.

Subsequently, the authorization key generation apparatus 40 transmits, to the first base station 20 as the serving base station, an HO Response message as a response message to the handover request (Step S740). Then, the first base station 20 transmits a Mobility_Base Station HandOver-Response (MOB_BSHO-RSP) message as a handover response message to the subscriber station 10 (Step S750).

The subscriber station determines a final base station, to which the subscriber station performs a handover, among a plurality of target base stations, and transmits a Mobility_HandOver-Indicator (MOB_HO-IND) message as a handover indication message including information regarding the finally determined base station to the first base station 20 as the serving base station (Step S760). Here, it is assumed that the second base station 21 is determined as the target base station. The first base station 20 transmits an HO Indication message, which is a message informing that the handover is performed, to the second base station 21 (Step S770).

The subscriber station 10 that completes the handover procedure to the first base station 20 as the serving base station needs to newly generate an authorization key corresponding to the second base station 21 as the target base station. Accordingly, the subscriber station 10 increases the authorization key generation number by “1” and sets the authorization key generation number to “2”. Then, the subscriber station 10 newly generates an authorization key AK₂ on the basis of the new authorization key generation number.

The subscriber station 10 transmits, to the second base station 21 as the target base station, a Ranging-Request (RNG-REQ) message as a ranging request message including a message authentication code CMAC-Digest generated using the updated second authorization key AK₂ and the authorization key generation number (0x02) set to “2” (Step S780).

The second base station 21 that receives the RNG-REQ message performs a message authentication function according to an exemplary embodiment of the present invention. If the value of CMAC-Digest in the message is correct, it is determined that the second base station 21 shares the same authorization key AK₂ as subscriber station. Further, when the authorization key generation number in the RNG-REQ message and the authorization key generation number stored in the base station are same, it is determined that the subscriber station and the base station share the same authorization key generation number, and thus the RNG-REQ message is processed.

Subsequently, the second base station 21 transmits, to the subscriber station 10, an Ranging-Response (RNG-RSP) message as a ranging response message including CMAC-Digest generated using the message authorization key derived from the second authorization key AK₂ and the authorization key generation number (0x02) set to “2” (Step S790).

As described above, the subscriber station 10 also performs message authentication using CMAC-Digest in the RNG-RSP message and confirms whether or not it shares the same authorization key as the base station. Further, it is determined whether or not it shares the authorization key generation number same as that of the base station.

Meanwhile, after transmitting the RNG-RSP message to the subscriber station 10, the second base station 21 transmits an HO Complete message as a handover completion message to the authorization key generation apparatus 40 (Step S800). Then, the authorization key generation apparatus 40 transmits the HO Complete message to the first base station 20 as a previous serving base station and the base stations, excluding the second base station 21 as a new serving base station, among the target base stations (Step S810).

If the RNG-RSP message received from the second base station 21 is the last message during the network re-entry procedure, the subscriber station 10 considers that the new authorization key AK₂ and the updated authorization key generation number (here, “2”) are correctly shared because the subscriber station has correctly received the RNG-RSP message. Then, the subscriber station deletes the first authorization key context (AK₁ Context) acquired after the initial access procedure (Step S820).

Further, after transmitting the HO Complete message, the authorization key generation apparatus 40 deletes the first authorization key context (AK₁ Context) to be stored and managed therein relative to the subscriber station 10. The previous serving base station 20 that receives the HO Complete message recognizes that the handover of the subscriber station 10 is completed, and deletes the first authorization key context (AK₁ Context) to be stored and managed therein when a predetermined time lapses after the HO Complete message is received (Step S830). In addition, after receiving the HO Complete message, the target base stations, excluding the second base station 21, recognize that the handover of the subscriber station is completed, and delete the second authorization key context (AK₂ Context) to be stored and managed therein when a predetermined time lapses after the HO Complete message is received.

In the above-described exemplary embodiment, in a case where the subscriber station 10 performs a handover from the first base station 20 to the second base station 21, if the first base station 20 and the second base station 21 does not exist under the same authorization key generation apparatus 40, a new authorization key generation apparatus that is managing the second base station 21 cannot obtain the associated authentication information, such as the PAK or the PMK corresponding to the subscriber station 10 that tries a handover, from the previous authorization key generation apparatus. In this case, the subscriber station 10, the second base station 21, the new authorization key generation apparatus, and the authentication server need to newly perform device authentication on the subscriber station or the base station, or user authentication. The new authentication procedure is performed in the same manner as the procedure shown in FIG. 6. At this time, the authorization key generation number is initialized to “1”.

As described above, in the exemplary embodiment of the present invention, if the handover of the subscriber station is completed, the authorization key contexts regarding the subscriber station stored in the serving base station, the authorization key generation apparatus, and the target base stations selected as a candidate base station to which the handover is performed are deleted, and new authorization key context is provided.

Particularly, in the exemplary embodiment of the present invention, the authorization key is generated on the basis of the authorization key generation number, which is changed each time the handover is successfully performed. Accordingly, because of this characteristic of the authorization key generation number, the authorization key maintained in a state where the subscriber station receives services from the first base station is different from the authorization key acquired in a case where the subscriber station performs the handover to the second base station and then performs the handover to the first base station again.

Accordingly, when the subscriber station performs the handover from the first base station to the second base station and then performs the handover to the first base station again, even if the replay attack by the malignant user occurs, the malignant user does not hold the authorization key generation number to be changed. Therefore, the authorization key or the message authentication code in the control message to be transmitted by the malignant user is not generated on the basis of the authorization key generation number that is currently held by the subscriber station or the base station. As a result, the subscriber station and the base station consider the control messages received from the malignant user as an unauthorized control message, and thus discard these unauthorized control messages.

According to the exemplary embodiment of the present invention, it is possible to powerfully cope with the replay attack by the malignant user using new authorization key context based on the authorization key generation number.

Next, a method of generating an authorization key according to a fourth exemplary embodiment of the present invention, which is performed in a case where, during a handover, the subscriber station cancels the handover, will be described. Here, a detailed description of a process performed in the same manner as the method of generating an authorization key according to the third exemplary embodiment will be omitted.

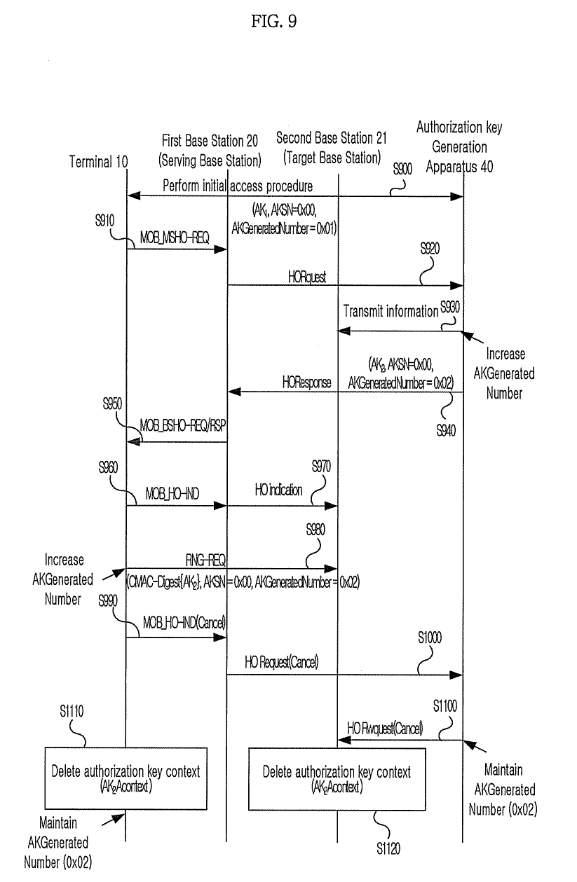

FIG. 9 is a flowchart illustrating a method of generating an authorization key according to the fourth exemplary embodiment of the present invention.

The subscriber station 10 performs the network access procedure in connection with the first base station 20 as the serving base station, the authorization key generation apparatus 40, and the authentication server (not shown), and then generates the first authorization key context (AK₁ Context) (Step S900). Next, in order to perform a handover to a new base station due to deterioration of the wireless channel environment, as described in the third exemplary embodiment, the subscriber station 10 performs a handover process while transmitting/receiving handover associated messages to/from the first base station 20, the authorization key generation apparatus 40, and the second base station 21 as the target base station (Steps S910 and S920).

At this time, similar to the third exemplary embodiment, the authorization key generation apparatus 40 generates the second authorization key AK₂ and transmits the authorization key, the authorization key sequence number, the authorization key lifetime, and the authorization key generation number set to “2” to the target base stations (Step S930). Similar to the third exemplary embodiment, if the subscriber station 10 completes the handover procedure with the first base station 20 as the previous serving base station (Steps S940-S970), the subscriber station 10 increases the authorization key generation number to “2” and generates the second authorization key AK₂ on the basis of the authorization key generation number. This process has been described above in detail with reference to FIG. 8, and thus a detailed description thereof will be omitted.

Subsequently, the subscriber station 10 transmits, to the second base station 21 as the target base station, an Ranging-Request (RNG-REQ) message as a ranging request message including a message authentication code generated using the newly generated second authorization key AK₂ and the authorization key generation number set to “2” (Step S980). In this case, as described above, the second base station 21 performs message authentication on the basis of the message authentication code so as to confirm whether or not it shares the same authorization key as the subscriber station 10, and confirms whether or not the authorization key generation numbers are same. Then, the second base station 21 processes the RNG-REQ message. Accordingly, the subscriber station 10 and the second base station 21 share the same second authorization key context (AK₂ Context).

Meanwhile, in a state where handover to the second base station 21 as the new serving base station is performed, the wireless channel environment relative to the first base station 20 as the previous serving base station may change for the better, and performing the current handover procedure may be canceled. In this case, the subscriber station 10 transmits an MOB_HO-IND message as a handover indication message including information regarding handover cancellation to the first base station 21 (Step S990).

The first base station 20 that receives the MOB_HO-IND message regarding handover cancellation from the subscriber station 10 transmits an HO Request message as a request message to cancel the handover to the authorization key generation apparatus 40 (Step S1000). Accordingly, the authorization key generation apparatus 40 transmits the HO Request message as a message to request handover cancellation to the target base stations (including the second base station) (Step S100).

The subscriber station 10 deletes the second authorization key context (AK₂ Context) that is shared with the second base station 21 as the target base station. Further, the authorization key generation apparatus 40 deletes the second authorization key context (AK₂ Context) to be stored and managed therein. In addition, the target base stations that receive the HO Request message regarding handover cancellation from the authorization key generation apparatus 40 also delete the second authorization key context (AK₂ Context) to be stored and managed therein (Steps S1110 and S1120).

Meanwhile, the subscriber station 10 and the authorization key generation apparatus 40 delete the second authorization key context (AK₂ Context) but store the authorization key generation number set to “2”. This is to increase the authorization key generation number by a predetermined value (+1) and set it to “3” when an authorization key needs to be subsequently updated.

Then, the subscriber station and the base station newly generate an authorization key on the basis of the authorization key generation number shared by them. Accordingly, even if the replay attack is made by the malignant user, since the malignant user does not hold the authorization key generation number, the authorization key or the message authentication code in the control message to be transmitted by the malignant user is different from the authorization key or the message authentication code that is generated on the basis of the authorization key generation number held by the subscriber station or the base station. As a result, the subscriber station and base station consider the control messages received from the malignant user as an unauthorized control message, and thus discard these unauthorized control messages.

The above-described method of generating an authorization key with the authorization key generation number can be applied to a case where message authorization keys are generated with the authorization key generation number. That is, the subscriber station and the base station manage the authorization key generation number, and the message authorization key that can protect the replay attack by the malignant user is generated using the authorization key generation number. As such, the method of generating a message authorization key used to generate a message authentication code on the basis of the authorization key generation number according to an exemplary embodiment of the present invention can be easily made by a person of ordinary skill in the art from the above-described exemplary embodiments, and thus the detailed description thereof will be omitted.

The above-described methods of generating an authorization key may be implemented as a program recorded on a computer readable recording medium. As the recording medium, all kinds of recording mediums that can store data to be readable by a computer may be used. For example, CD-ROMs, magnetic tapes, or floppy disks are exemplified. Further, a carrier wave (for example, transmission through Internet) may be used.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiments of the present invention, a more secure and strong authorization key can be generated in a wireless communication system. Specifically, the following effects can be obtained.

### INDUSTRIAL APPLICABILITY

First, when the CMAC packet number counter, which is used to protect against the replay attack on the control message to be transmitted and received between the subscriber station and the base station, overflows, it is possible to update the authorization key without performing an unnecessary re-authentication procedure.

Second, even if the subscriber station receives services from the same base stations and has the same PAK or PMK, it is possible to generate a new authorization key.

Third, the function for protecting the replay attack by the malignant user as well as the message authentication function on the control message to be transmitted between the subscriber station and the base station is perfectly supported. Therefore, a stable system operation can be performed and system performance can be improved.

1. A method of generating an authorization key corresponding to an authenticated subscriber station in a wireless communication system, the method comprising:
acquiring at least one root key for generating the authorization key through an authentication procedure according to a authentication mode negotiated by a subscriber station and a base station;
determining an authorization key generation number; and
generating the authorization key on the basis of the root key and the authorization key generation number.

2. The method of claim 1, wherein the generating of the authorization key includes:
generating the authorization key by further using a subscriber station identifier and a base station identifier.

3. The method of claim 2, wherein the generating of the authorization key includes:
generating an input key through a predetermined operation with the root key;
setting the subscriber station identifier, the base station identifier, the authorization key generation number, and a predetermined string of characters as input data; and
generating the authorization key through a key generation algorithm based on the input key and the input data.

4. The method of claim 3, wherein the root key is at least one of a Primary Authorization Key (PAK) obtained through a Rivest Shamir Adleman (RSA) based authentication procedure and a Pairwise Master Key (PMK) obtained through an Extensible Authentication Protocol (EAP) based authentication procedure.

5. The method of claim 1, wherein the authorization key generation number is increased by a predetermined value each time the authorization key is generated.

6. The method of claim 1, further comprising, after generating the authorization key, confirming whether or not the subscriber station and the base station share the same authorization key and the same authorization key generation number.

7. A method of generating an authorization key corresponding to an authenticated subscriber station in a wireless communication system, the method comprising:
acquiring, at a base station, an authorization key based on an authorization key generation number;
transmitting, at the base station, an SA-Traffic Encryption Key (SA-TEK) challenge message including the authorization key generation number and a message authentication code for performing message authentication function to the subscriber station;
receiving, at the base station, an SA-TEK request message from the subscriber station that has received the SA-TEK challenge message, the SA-TEK request message including an authorization key generation number and a message authentication code generated by the subscriber station; and
transmitting, at the base station, an SA-TEK response message to the subscriber station so as to confirm that the base station and the subscriber station share the same authorization key and the same authorization key generation number.

8. A method of generating an authorization key corresponding to an authenticated subscriber station in a wireless communication system, the method comprising:
receiving, at a subscriber station, an SA-TEK challenge message including an authorization key generation number and a message authentication code for performing message authentication function from a base station;
transmitting, at the subscriber station, an SA-TEK request message including an authorization key generation number and a message authentication code to the base station; and
receiving, at the subscriber station, an SA-TEK response message from the base station so as to confirm that the base station and the subscriber station share the same authorization key and the same authorization key generation number.

9. The method of claim 7, wherein the method is performed in at least one of a case where an initial authentication procedure between the subscriber station and the base station is performed, a case where a re-authentication procedure is performed after completing the initial authentication procedure, or a case where a counter value of control messages transmitted and received between the subscriber station and the base station overflows a predetermined value.

10. The method of claim 9, wherein the base station adds an authorization key update indication field into the SA-TEK challenge message and transmits the SA-TEK challenge message,
wherein the authorization key update indication field informs that the authorization key has been newly generated since the values of uplink/downlink CMAC packet number counters for counting the control messages have exceeded predetermined values, respectively.

11. A method of generating an authorization key corresponding to an authenticated subscriber station in a wireless communication system, the method comprising:
generating, at a subscriber station, the authorization key on the basis of an authorization key generation number;
transmitting, at the subscriber station, a ranging (RNG) request message including the authorization key generation number and a message authentication code for performing message authentication function to a base station;
receiving, at the subscriber station, a RNG response message from the base station that has received the RNG request message, the RNG response message including an authorization key generation number and a message authentication code generated by the base station; and
confirming, at the subscriber station, that the subscriber station shares the same authorization key and the same authorization key generation number as the base station when the subscriber station receives the valid RNG response message.

12. A method of generating an authorization key corresponding to an authenticated subscriber station in a wireless communication system, the method comprising:
receiving, at a base station, a ranging (RNG) request message from the subscriber station, the RNG request message including an authorization key generation number and a message authentication code for performing message authentication function;
generating, at the base station, a RNG response message including a authorization key generation number and a message authentication generated by the base station; and
transmitting, at the base station, the RNG response message to the subscriber station so as to confirm that the subscriber station and the base station share the same authorization key and the same authorization key generation number.

13. The method of claim 11, wherein the method is performed in at least one of a case where a handover procedure between the subscriber station and the base station is successfully performed, a case where the handover procedure between the subscriber station and the base station is canceled, a case where the location of the subscriber station is updated, or a case where a drop procedure for the subscriber station is performed.

14. The method of claim 13, wherein, after it is confirmed that the subscriber station and the second base station share the same authorization key and the same authorization key generation number by performing the method as the subscriber station performs a handover from a first base station to a second base station, the authorization key generation number is maintained even if the authorization key context is deleted when the subscriber station cancels the handover.

15. The method of claim 7, further comprising, if the base station or the subscriber station receives a predetermined message:
determining whether or not a message authentication code included in the received message is identical to the message authentication code generated in the base station or the subscriber station;
determining that the received message is an authorized message when the message authentication codes are same;
determining whether or not the authorization key generation number included in the received message is identical to the authorization key generation number stored in the base station or the subscriber station; and
determining that the base station and the subscriber station share the same authorization key generation number when the two authorization key generation numbers are same.

16. The method of claim 7, wherein the message authentication code is a code that is generated with a message authorization key derived from authorization key generated by the base station or the subscriber station.

17. The method of claim 16, wherein a message authentication code mode corresponding to the message authentication code is Cipher-based Message Authentication Code (CMAC).

18. The method of claim 7, wherein the generating of the authorization key includes generating the authorization key on the basis of a root key obtained through an authentication procedure, the authorization key generation number, a subscriber station identifier, a base station identifier, and a string of characters.
